(19) United States
(12) Patent Application Publication
(10) Pub. No.: US 2012/0300253 A1
(43) Pub. Date: Nov. 29, 2012

(54) DATA PROCESSING APPARATUS, DATA PROCESSING METHOD, AND COMPUTER-READABLE RECORDING MEDIUM

(75) Inventor: Tetsuhiko Omori, Chiba (JP)

(73) Assignee: Ricoh Company, Limited, Tokyo (JP)

(21) Appl. No.: 13/470,438

(22) Filed: May 14, 2012

(30) Foreign Application Priority Data
May 23, 2011 (JP) 2011-114819

(51) Int. Cl. G06F 3/12

(52) U.S. Cl. 358/1.15

(57) ABSTRACT

A data processing apparatus includes a workflow storage unit configured to store therein a workflow indicating content of processing to be performed on data; a reading unit configured to, when receiving data, identification information of the workflow, and destination information of the data, read the workflow corresponding to the identification information from the workflow storage unit; a processing unit configured to process the received data based on the workflow and deliver the processed data to an apparatus indicated by the destination information; and an availability notification unit configured to, in response to an operation check request that includes the identification information, cause the reading unit to read the workflow corresponding to the identification information from the workflow storage unit, cause the processing unit to perform an operation check based on the workflow thus read, and issue a notification of a result of the operation check.

### CROSS-REFERENCE TO RELATED APPLICATIONS

The present application claims priority to and incorporates by reference the entire contents of Japanese Patent Application No. 2011-114819 filed in Japan on May 23, 2011.

### BACKGROUND OF THE INVENTION

1. Field of the Invention

The present invention relates to a data processing apparatus, a data processing method, and a computer-readable recording medium.

2. Description of the Related Art

There are known data delivery systems that connect a plurality of terminal devices to a data processing apparatus (also called a “data delivery apparatus”) in a communicable manner via a network.

In each of such data delivery systems, the terminal devices can send data to the data processing apparatus, which can in turn apply delivery processing to the data based on a workflow prepared in advance.

The workflow is a procedure in which processes to be performed on the data are put together, and enables the data processing apparatus to perform one or a combination of multiple types of processes that can be performed by the data processing apparatus.

As an example of the processes included in the workflow, there is a process in which the data processing apparatus converts image data received from a terminal device into that of a specified format, and then delivers the converted data to a file server. There is also a process of delivering electronic mail data received from a terminal device to a mail server.

Furthermore, such data delivery systems are sometimes provided with an authentication server for performing user management.

As examples of the terminal devices, there are image processing apparatuses, such as a printer, a copying machine, a facsimile apparatus, a scanner, and a digital multifunction peripheral (MFP) having functions of these apparatuses, and information processing apparatuses, such as a personal computer.

In such data delivery systems as described above, there have conventionally been data processing apparatuses (refer, for example, to Japanese Patent Application Laid-open No. 2009-223728) each of which employs, as a method allowing a user of a terminal device who uses a workflow in the data processing apparatus to judge whether a process requested to the data processing apparatus is successfully completed, a method in which the user makes an inquiry to the data processing apparatus and makes a check according to the log of the processing result, or a method in which the processing result is notified to the terminal device via e-mail or the like.

However, there has been a problem that the user of the terminal device has no way of knowing that a process in the workflow will fail until the process is actually executed.

For example, in the case that a server at a destination has no free space, the user has no way of knowing the lack of free space and does not come to know that a requested process in the workflow will fail until the user actually uses the data processing apparatus and is notified by the data processing apparatus of the failure of delivery.

Therefore, there is a need for a data processing apparatus and a data processing method which allow a user to easily check whether processes in a workflow will be performed successfully before executing the processes.

### SUMMARY OF THE INVENTION

It is an object of the present invention to at least partially solve the problems in the conventional technology.

According to an embodiment, there is provided a data processing apparatus that includes a workflow storage unit configured to store therein a workflow indicating content of processing to be performed on data; a reading unit configured to, when receiving data, identification information of a workflow to be performed on the data, and destination information of the data, read the workflow corresponding to the identification information from the workflow storage unit; a processing unit configured to process the received data based on the workflow read by the reading unit and deliver the processed data to an apparatus indicated by the destination information; and an availability notification unit configured to, in response to an operation check request that includes the identification information of the workflow stored in the workflow storage unit, cause the reading unit to read the workflow corresponding to the identification information from the workflow storage unit, cause the processing unit to perform an operation check based on the workflow thus read, and issue a notification of a result of the operation check.

According to another embodiment, there is provided a data processing method that includes reading, when receiving data, identification information of a workflow to be performed on the data, and destination information of the data, the workflow corresponding to the identification information from a workflow storage unit, the workflow indicating content of processing to be performed on the data; processing the received data based on the workflow; delivering the processed data to an apparatus indicated by the destination information; and in response to an operation check request that includes the identification information of the workflow stored in the workflow storage unit, reading the workflow corresponding to the identification information from the workflow storage unit, performing an operation check based on the workflow thus read, and issuing a notification of a result of the operation check.

According to still another embodiment, there is provided a non-transitory computer-readable recording medium with an executable program stored thereon. The program instructs a computer to perform reading, when receiving data, identification information of a workflow to be performed on the data, and destination information of the data, the workflow corresponding to the identification information from a workflow storage unit, the workflow indicating content of processing to be performed on the data; processing the received data based on the workflow; delivering the processed data to an apparatus indicated by the destination information; and in response to an operation check request that includes the identification information of the workflow stored in the workflow storage unit, reading the workflow corresponding to the identification information from the workflow storage unit, performing an operation check based on the workflow thus read, and issuing a notification of a result of the operation check.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a structure of a data delivery system of an embodiment of the invention;

FIG. 2 is a flowchart illustrating processes of an image forming apparatus illustrated in FIG. 1;

FIG. 3 is a flowchart illustrating processes of a data delivery apparatus illustrated in FIG. 1;

FIG. 4 is a diagram illustrating an example of a workflow list of workflows to be subjected to an operation check;

FIG. 5 is a diagram illustrating an example of parameters used when operations of workflows are checked;

FIG. 6 is a diagram illustrating, similarly to FIG. 5, an example of parameters used when operations of workflows are checked;

FIG. 7 is a diagram illustrating an example of a workflow selection screen;

FIG. 8 illustrates examples of processing procedures of workflows;

FIG. 9 is a diagram illustrating an example of a workflow screen; and

FIG. 10 is a structure diagram illustrating an internal structure example of an image forming apparatus of another embodiment of the present invention.

### DETAILED DESCRIPTION OF THE PREFERRED EMBODIMENTS

Embodiments for implementing the present invention will be specifically described below based on the accompanying drawings.

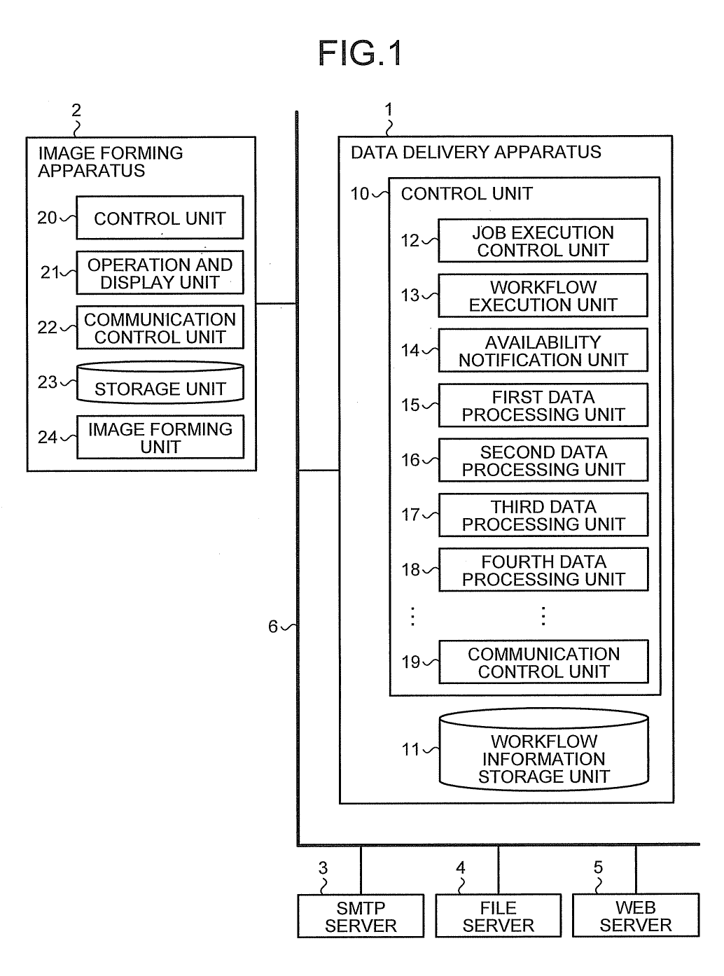

FIG. 1 is a block diagram illustrating a structure of a data delivery system of an embodiment of the invention.

In this data delivery system, a data delivery apparatus 1 is connected via a network 6 to an image forming apparatus 2, an SMTP server 3, a file server 4, a web server 5, and other apparatuses (not illustrated) on the network 6 so as to be capable of data communication with each of these apparatuses and servers.

The data delivery apparatus 1 receives data from other apparatuses including the image forming apparatus 2, and delivers, based on specified workflows, the data to apparatuses including the SMTP server 3, the file server 4, and the web server 5.

Although the description will be made below of the case in which the image forming apparatus 2 sends data to the data delivery apparatus 1, which in turn processes the data based on the workflows and delivers the processed data to the SMTP server 3, the file server 4, or the web server 5, these operations can be performed on the other apparatuses (not illustrated) on the network 6 in the same manner.

The image forming apparatus 2 is a printer, a copying machine, a facsimile apparatus, a scanner, or an MFP having functions of these apparatuses, which generates data to be processed according to the workflows, and sends the data to the data delivery apparatus 1.

The SMTP (simple mail transfer protocol) server 3 is a server for sending electronic mail, and stores therein electronic mail data delivered from the data delivery apparatus 1. The stored electronic mail data is received by, for example, a POP (post office protocol) server, and delivered to a destination of the electronic mail data.

The file server 4 stores therein data delivered from the data delivery apparatus 1 in the form of a file, allows the image forming apparatus 2 to search for data, and provides the found data.

The web server 5 is a server having a function to send and receive data via the WWW (World Wide Web), and allows the apparatuses on the network 6 to communicate over the Internet.

The data delivery apparatus 1 is materialized by a microcomputer including a central processing unit (CPU), a read-only memory (ROM), and a random access memory (RAM), and is provided with a control unit 10 and a workflow information storage unit 11.

The control unit 10 is in charge of controlling the entire data delivery apparatus 1, and is also provided with functions of a job execution control unit 12, a workflow execution unit 13, a availability notification unit 14, a first data processing unit 15, a second data processing unit 16, a third data processing unit 17, a fourth data processing unit 18, and a communication control unit 19.

The workflow information storage unit 11 is a storage unit including a hard disk device, and stores therein various types of data including job data received from the image forming apparatus 2, workflows indicating contents of processing to be performed on data, and workflow screen information to be provided to the image forming apparatus 2.

The workflow information storage unit 11 stores therein in advance a plurality of types of workflows including workflows to execute one from a plurality of types of data that can be executed in the data delivery apparatus 1, and workflows to execute a combination of a plurality of types of data.

These workflows are stored with respective corresponding identification information, and specified workflows can be read based on the identification information.

The above-mentioned data includes various types of data such as document data generated in the image forming apparatus 2, electronic mail data, image data read by an image reading function of the image forming apparatus 2, and facsimile data received through facsimile communication.

The above-mentioned workflow screen information is data for displaying a workflow selection screen and a workflow screen on the image forming apparatus 2.

The job execution control unit 12 stores data received by the communication control unit 19 from the image forming apparatus 2 on the network 6 in the workflow information storage unit 11 as job data, and requests the workflow execution unit 13 to process the job data.

The workflow execution unit 13 causes the first to the fourth data processing units 15 to 18 to process the respective job data based on the workflows performed on such job data. In the present embodiment, the first to the fourth data processing units 15 to 18 are illustrated, and other data processing units are not illustrated.

The availability notification unit 14 requests the data processing units to check operations, and determines whether to issue a notification to a user based on the result of the request.

The first to the fourth data processing units 15 to 18 are functional units each performing each process of the contents of processing listed in the workflows.

For example, the first data processing unit 15 performs a predetermined image conversion process on data.

The second data processing unit 16 performs processing to deliver data to the SMTP server 3. In this case, the electronic mail data is directly delivered, and image data is delivered by being attached to an electronic mail message.

The third data processing unit 17 performs processing to deliver data to a predetermined folder in the file server 4.

The fourth data processing unit 18 applies OCR processing to data.

The OCR processing is a process to recognize characters from image data and converts the recognized characters into code data.

The communication control unit 19 sends and receives data via the network 6 to and from apparatuses including the image forming apparatus 2, the SMTP server 3, the file server 4, and the web server 5.

The image forming apparatus 2 is materialized by a microcomputer including a CPU, a ROM, and a RAM, and is provided with a control unit 20, an operation and display unit 21, a communication control unit 22, a storage unit 23, and an image forming unit 24.

The control unit 20 is in charge of controlling the entire image forming apparatus 2.

The operation and display unit 21 is an operation panel composed of an operating section where the user enters various types of operational information, various operation screens including the workflow selection screen and the workflow screen used by the user, and a display unit that displays various types of information to be notified to the user.

The communication control unit 22 sends and receives data via the network 6 to and from apparatuses including the data delivery apparatus 1, the SMTP server 3, the file server 4, and the web server 5.

The storage unit 23 is a storage unit including a hard disk device, and stores therein various types of data including data to be sent to the data delivery apparatus 1 and information of the cooperating data delivery apparatus 1.

The image forming unit 24 is provided with the image reading function to scan an image of a document and produce image data (scan data) of the read image, and an image forming function to print on paper the image data produced by the image reading function, the document data generated in the image forming apparatus 2, and document data and image data received from other apparatuses via the network 6.

The detailed structures and operations of the image reading function and the image forming function in the image forming unit 24 are omitted because such structures and operations are well known.

In other words, the workflow information storage unit 11 performs a function of a workflow storage unit that stores therein workflows indicating contents of processing to be performed on data.

In addition, the job execution control unit 12 performs a function of a reading unit that, when receiving data, identification information of workflows to be performed on the data, and destination information of the data, reads the workflows corresponding to the identification information from the workflow storage unit.

Moreover, the workflow execution unit 13, the first to the fourth data processing units 15 to 18, and the communication control unit 19 perform a function of a processing unit that processes the received data based on the workflows read by the reading unit and delivers the data to apparatuses on the network 6 indicated by the destination information.

Furthermore, the availability notification unit 14 and the communication control unit 19 performs a function of a availability notification unit that, when an operation check request is received in addition to the identification information of the workflows in the workflow storage unit, causes the reading unit to read the workflows corresponding to the identification information from the workflow storage unit, causes the processing unit to perform an operation check based on the workflows thus read, and then issues a notification of the result of the operation check.

The functions of the above-mentioned units may be performed by storing a computer program described below in the ROM or the RAM (corresponding to a computer-readable recording medium) in the control unit 10 of the data delivery apparatus 1, and making the CPU execute procedures of the programs to execute data processing methods described below.

An executable program instructs a computer to perform: reading, when receiving data, identification information of a workflow to be performed on the data, and destination information of the data, the workflow corresponding to the identification information from a workflow storage unit, the workflow indicating content of processing to be performed on the data; processing the received data based on the workflow; delivering the processed data to an apparatus indicated by the destination information; and in response to an operation check request that includes the identification information of the workflow stored in the workflow storage unit, reading the workflow corresponding to the identification information from the workflow storage unit, performing an operation check based on the workflow thus read, and issuing a notification of a result of the operation check.

The executable program may further instruct the computer to performs: at least one of periodically performing, at a preset interval, a process in which an operation check is performed based on the workflow stored in the workflow storage unit and a notification of a result of the operation check is issued, selecting a type of the workflow to be subjected to the operation check, and changing the interval.

In addition, the workflow storage unit can preferably store therein a plurality of types of workflows.

Next, processes when workflows are used in the image forming apparatus 2 will be described.

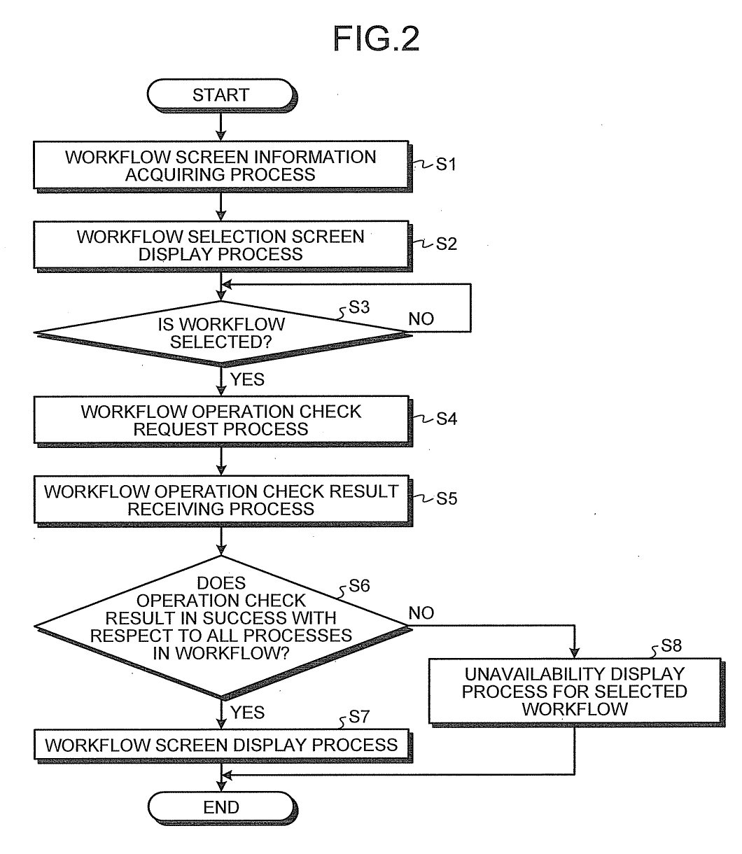

FIG. 2 is a flowchart illustrating the processes when workflows are used in the image forming apparatus 2 illustrated in FIG. 1.

The control unit 20 of the image forming apparatus 2 performs the processes illustrated in FIG. 2 when an instruction input to use a workflow is issued from the operation and display unit 21.

The control unit 20 performs a workflow screen information acquiring process of Step S1.

The workflow screen information acquiring process reads destination information of the data delivery apparatus 1 among items of information of the cooperating data delivery apparatus 1 that are stored in the storage unit 23.

The process further gains access to the data delivery apparatus 1 on the network 6 via the communication control unit 22 based on the destination information.

Then, the process requests the data delivery apparatus 1 via the communication control unit 22 for workflow screen information including workflow selection screen information and information of workflow screen, and receives and acquires the workflow screen information sent as a response from the data delivery apparatus 1.

Next, the control unit 20 performs a workflow selection screen display process of Step S2.

The workflow selection screen display process displays, on the operation and display unit 21, a workflow selection screen based on the workflow selection screen information of the workflow screen information received from the data delivery apparatus 1.

Then, at Step S3, the control unit 20 determines whether a workflow is selected.

In this determination, the control unit 20 determines whether any workflow is selected among a plurality of workflows on the workflow selection screen, repeats the determination process until any workflow is selected, and proceeds to the next step when a workflow is selected.

Next, at Step S4, the control unit 20 performs a workflow operation check request process.

The workflow operation check request process sends a workflow operation check request together with the identification information of the workflow selected above to the data delivery apparatus 1 via the communication control unit 22.

Then, at Step S5, the control unit 20 performs a workflow operation check result receiving process.

The workflow operation check result receiving process receives, as a result of the workflow operation check requested above, an availability notification or an unavailability notification for the workflow selected above, from the data delivery apparatus 1 via the communication control unit 22.

Next, at Step S6, the control unit 20 determines whether the operation check has been successful with respect to all processes in the workflow.

In this determination, if the availability notification for the workflow selected above is received as the result of the workflow operation check requested above, the control unit 20 determines that the operation check has been successful with respect to all processes in the workflow, and proceeds to Step S7, while if the unavailability notification is received, the control unit 20 determines that the operation check has not been successful with respect to all processes in the workflow, and proceeds to Step S8.

Then, in a workflow screen display process of Step S7, the control unit 20 explicitly indicates on the operation and display unit 21 that the workflow selected above is available, and terminates this series of processes.

Alternatively, in an unavailability display process for the selected workflow of Step S8, the control unit 20 displays a message on the operation and display unit 21 that the workflow selected above is not available, and terminates this series of processes.

Next, the workflow operation check process in the data delivery apparatus 1 will be described.

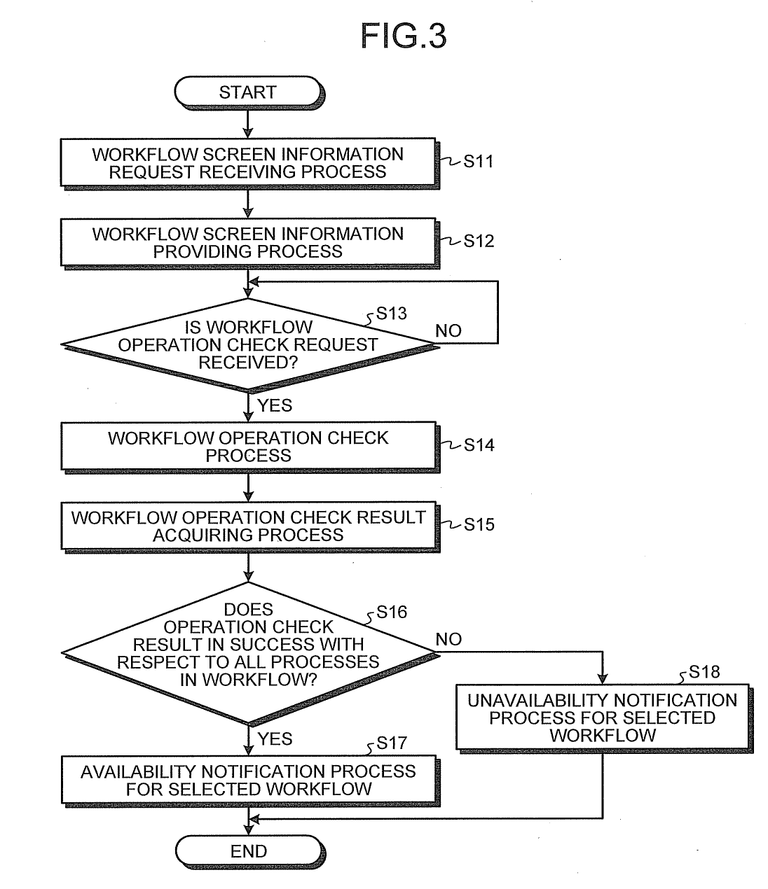

FIG. 3 is a flowchart illustrating the workflow operation check process in the data delivery apparatus 1 illustrated in FIG. 1.

The data delivery apparatus 1 of FIG. 1 performs a workflow screen information request receiving process at Step S11.

In the workflow screen information request receiving process, the control unit 10 is accessed from the image forming apparatus 2 via the communication control unit 19, and receives the request for the workflow screen information from the image forming apparatus 2.

Next, the control unit 10 performs a workflow screen information providing process of Step S12.

In the workflow screen information providing process, the job execution control unit 12 reads the workflow screen information including the workflow selection screen information and the information of workflow screen from the workflow information storage unit 11, and sends the workflow screen information to the image forming apparatus 2 via the communication control unit 19.

Next, at Step S13, the control unit 10 determines whether the workflow operation check request is received together with the identification information of the workflow from the image forming apparatus 2 via the communication control unit 19.

In this determination, the control unit 10 repeats the determination process if the request is determined to be not received, and proceeds to Step S14 if the request is determined to be received.

Then, at Step S14, the control unit 10 performs the workflow operation check process.

In the workflow operation check process, the availability notification unit 14 instructs the job execution control unit 12 to read the workflow based on the identification information of the workflow received from the image forming apparatus 2.

The job execution control unit 12 reads the workflow corresponding to the identification information from the workflow information storage unit 11, and sends the workflow to the availability notification unit 14.

Based on the workflow received from the job execution control unit 12, the availability notification unit 14 causes the workflow execution unit 13 to have the operation check performed by the first to the fourth data processing units 15 to 18.

The operation check is performed such that, for example, in the image conversion process of the first data processing unit 15, it is checked whether the image conversion process can be applied properly to the data stored in advance in the workflow information storage unit 11.

In addition, in the SMTP delivery processing of the second data processing unit 16, it is checked whether the data stored in advance in the workflow information storage unit 11 can be delivered to the SMTP server 3.

Moreover, in the folder delivery processing of the third data processing unit 17, it is checked whether the data stored in advance in the workflow information storage unit 11 can be stored in the file server 4.

Furthermore, in the OCR process of the fourth data processing unit 18, it is checked whether the OCR process can be performed on the image data stored in advance in the workflow information storage unit 11 to obtain code data.

Next, at Step S15, the control unit 10 performs a workflow operation check result acquiring process.

In the workflow operation check result acquiring process, the availability notification unit 14 collects and acquires the operation check results in the first to the fourth data processing units 15 to 18.

Subsequently, at Step S16, the control unit 10 determines whether the operation check has been successful with respect to all processes in the workflow.

In this determination, the control unit 10 proceeds to Step S17 if the requested operation check has been successful with respect to all processes in the workflow, and proceeds to Step S18 if the requested operation check has not been successful with respect to any one of the processes in the workflow.

Then, in the availability notification process for the workflow selected above of Step S17, the control unit 10 notifies the image forming apparatus 2 via the communication control unit 19 that the workflow selected above is available, and terminates this series of processes.

Alternatively, in the unavailability notification process for the workflow selected above of Step S18, the control unit 10 notifies the image forming apparatus 2 via the communication control unit 19 that the workflow selected above is not available, and terminates this series of processes.

In the manner described above, based on the request from the image forming apparatus 2, the data delivery apparatus 1 causes the first to the fourth data processing units 15 to 18 to perform the predetermined operation check process according to the settings set in advance based on the workflow.

Then, the availability notification unit 14 collects the operation check results of the first to the fourth data processing units 15 to 18, and if any of the processes has failed to operate, notifies the image forming apparatus 2 that the workflow of which operation check is requested is not available.

Based on this notification from the data delivery apparatus 1, the image forming apparatus 2 displays a message to the user that the selected workflow is not available.

Therefore, the user is able to know in advance whether the workflow that the user wants to use is available in the data delivery apparatus 1 before starting to use the workflow. Thus, a working efficiency can be improved by avoiding the execution of a workflow that will result in a failure if executed.

Next, after the above-described operation check process is finished, when the image forming apparatus 2 requests the data delivery apparatus 1 to process workflows, the control unit 20 of the image forming apparatus 2 sends the identification information of workflows selected by the user, the data to which the selected workflows are applied, and the destination information of the data to the data delivery apparatus 1 via the communication control unit 22.

When the control unit 10 of the data delivery apparatus 1 receives the data, the identification information of the workflows to be performed on the data, and the destination information of the data from the image forming apparatus 2 via the communication control unit 19, the job execution control unit 12 temporarily stores those data and information items in the workflow information storage unit 11.

The job execution control unit 12 then reads workflows corresponding to the identification information from the workflow information storage unit 11, and passes the workflows to the workflow execution unit 13.

The workflow execution unit 13 in turn performs processing of the data received by operating any one or more of data processing units including the first to the fourth data processing units 15 to 18 based on the workflows, and delivers the data via the communication control unit 19 to an apparatus (in the case of the present embodiment, the SMTP server 3, the file server 4, or the web server 5) on the network 6 indicated by the destination information.

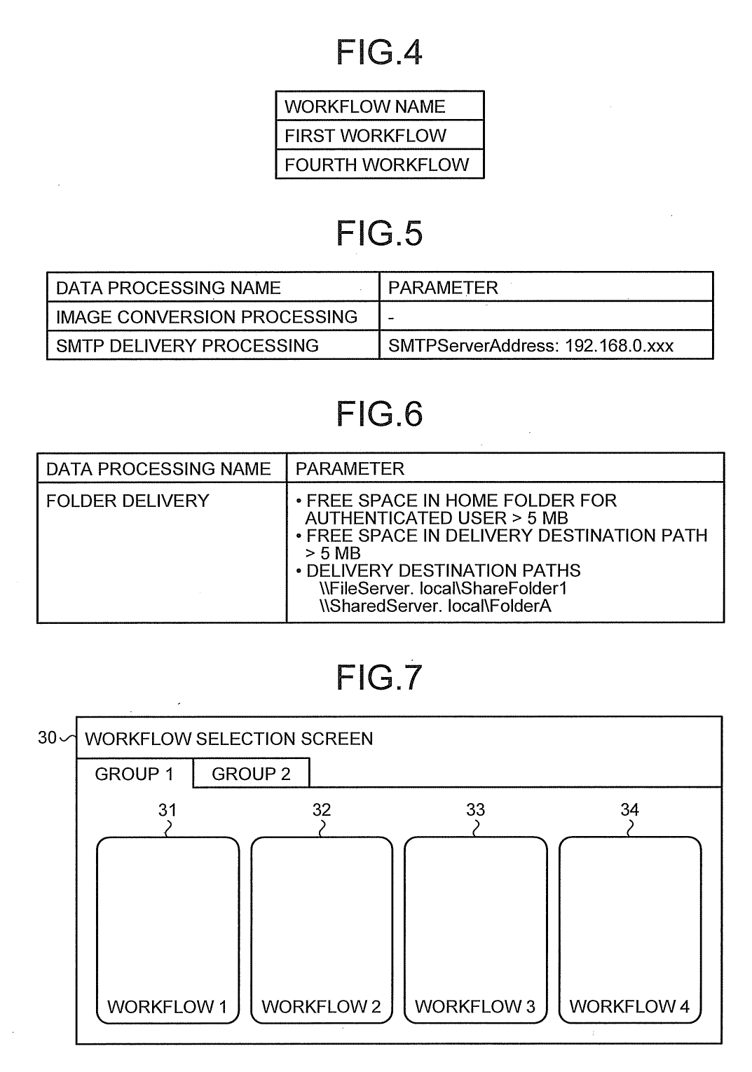

FIG. 4 is a diagram illustrating an example of a workflow list of workflows to be subjected to the operation check.

For example, if the user selects a first workflow and a fourth workflow from the workflow selection screen, the control unit 20 of the image forming apparatus 2 generates a workflow list as illustrated in FIG. 4 before executing the workflows, and sends to the data delivery apparatus 1 respective identification information of the first and the fourth workflows together with an operation check request for the first and the fourth workflows.

FIG. 5 is a diagram illustrating an example of parameters used when operations of workflows are checked.

The data delivery apparatus 1 stores in advance, in the workflow information storage unit 11, each parameter used for an operation check of each of the contents of processing listed in each workflow.

As illustrated in FIG. 5, for example, no particular parameter is set for the image conversion processing, and as a parameter for the SMTP delivery processing, the address of the SMTP server 3 is stored as SMTPServerAddress=“192.168.0.xxx”.

If the SMTP delivery processing is included in a workflow of which operation check is requested, the second data processing unit 16 checks the operation of delivery to the SMTP server 3 according to the address mentioned above, that is, checks whether data prepared in advance for an operation check is stored in the SMTP server 3. In this case, if the data is not stored in the SMTP server 3, the first data processing unit 15 determines that the SMTP delivery processing will result in a failure.

FIG. 6 is a diagram illustrating, similarly to FIG. 5, an example of parameters used when operations of workflows are checked.

As illustrated in FIG. 6, the following three items are stored for the folder delivery processing.

1. The free space in the home folder for the authenticated user exceeds 5 MB.

2. The free space in (the folder in) the destination path exceeds 5 MB.

3. Destination paths are
“\\FileServer.local\ShareFolder1” and
“\\SharedServer.local\FolderA”.

If the folder delivery processing is included in a workflow of which operation check is requested, the third data processing unit 17 accesses the file server 4, and checks the respective folders indicated by the destination paths mentioned above to ensure that the free space in the home folder for the authenticated user exceeds 5 MB, and that the free space in the folder in the destination path exceeds 5 MB.

In this case, if either of the free spaces is 5 MB or less, the second data processing unit 16 determines that the folder delivery processing will result in a failure.

FIG. 7 is a diagram illustrating an example of the workflow selection screen.

Based on the workflow selection screen information acquired from the data delivery apparatus 1, the image forming apparatus 2 displays a workflow selection screen 30 as illustrated in FIG. 7 on the operation and display unit 21.

The workflow selection screen 30 displays selection buttons 31 to 34 for a workflow 1 to a workflow 4, respectively, which are used by the user to select workflows available in the data delivery apparatus 1.

When the user depresses desired workflow buttons, such as the selection button 31 for the first workflow and the selection button 34 for the fourth workflow, selected from the workflow selection screen 30, the image forming apparatus 2 requests the data delivery apparatus 1 to check operations of the first workflow and the fourth workflow according to the above-mentioned processes.

Then, when the data delivery apparatus 1 has sent, for example, a notification that the first workflow is available and a notification that the fourth workflow is not available, the selection button 31 for the first workflow is displayed in full-brightness indicating a selectable state while the selection button 34 for the fourth workflow is displayed in half-brightness indicating an unselectable state or an icon indicating an unavailable state is displayed over the selection button 34.

In addition, for the fourth workflow, for example, a message “The selected one, Fourth Workflow is now not available. Please contact your system administrator or retry after a while.” is displayed as a workflow unavailability message, thus notifying the user that the selected workflow is not available.

If the data delivery apparatus 1 notifies the image forming apparatus 2 of a detailed cause of unavailability in addition to making the notification of the unavailability, the image forming apparatus 2 can display the cause in the workflow unavailability message, and if the content of the cause can be understood by the user without the need of the administrator, the user can handle the problem personally.

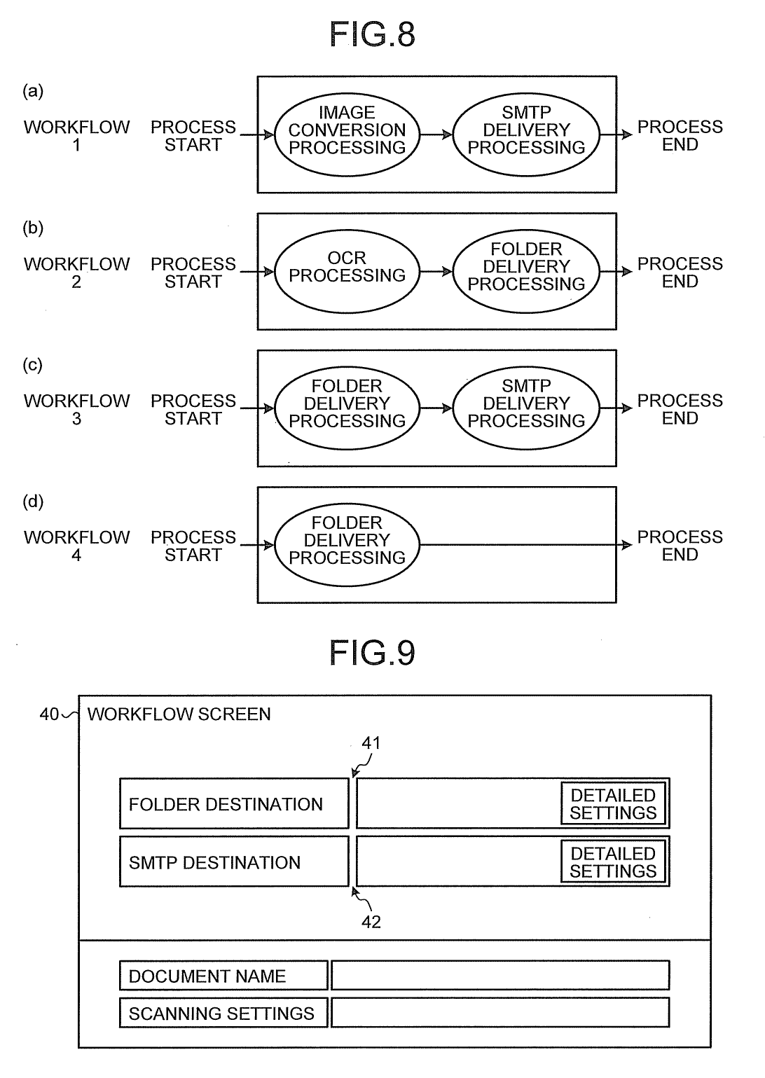

FIG. 8 illustrates examples of processing procedures of the workflows.

The processing procedures that can be executed by using the selection buttons 31 to 34 for the workflow 1 to the workflow 4 illustrated in FIG. 7 are, for example, as illustrated in FIG. 8.

For example, as illustrated in (a) of FIG. 8, a process that can be executed by using the selection button 31 for the workflow 1 applies the image conversion processing (such as conversion of image format or conversion from bitmap data to JPEG compressed data) to data, and thereafter, delivers the converted data to the SMTP server 3 by using the SMTP delivery processing.

In addition, for example, as illustrated in (b) of FIG. 8, a process that can be executed by using the selection button 32 for the workflow 2 applies the OCR processing to data, and thereafter, delivers the converted data to a specified folder in the file server 4 by using the folder delivery processing to store the data in that folder.

Moreover, for example, as illustrated in (c) of FIG. 8, a process that can be executed by using the selection button 33 for the workflow 3 delivers data to a specified folder in the file server 4 by using the folder delivery processing to store the data in that folder, and delivers the data to the SMTP server 3 by using the SMTP delivery processing.

Furthermore, for example, as illustrated in (d) of FIG. 8, a process that can be executed by using the selection button 34 for the workflow 4 delivers data to a specified folder in the file server 4 by using the folder delivery processing to store the data in that folder.

FIG. 9 is a diagram illustrating an example of the workflow screen.

A workflow screen 40 is a screen, for example, for detailed setting of the workflow 3 that has been notified by the above-described operation check process to be available. The user enters, in a folder destination specification field 41 from the operation and display unit 21, the destination path for a folder in the file server 4 in which the data is to be stored.

The user further enters the address of the SMTP server 3 in an SMTP destination specification field 42.

Then, when the user selects the data to which the workflow 3 is applied and enters an instruction to execute the workflow 3, the image forming apparatus 2 sends to the data delivery apparatus 1 the data, the identification information of the workflow 3 to be performed on the data, and the destination information (in this case, the destination path for the folder in the file server 4 and the address of the SMTP server 3) of the data, together with an execution instruction of the workflow 3.

In the data delivery apparatus 1, the availability notification unit 14 may be configured to function as an execution unit that has the above-described operation check of the workflow performed periodically at a preset interval.

In this case, the availability notification unit 14 is set in advance with a schedule such as at a fixed time every day or at predetermined intervals in a day, as an execution condition of the workflow.

Based on the above-described interval, the availability notification unit 14 periodically performs the operation check of each workflow stored in the workflow information storage unit 11 in a manner described above, and notifies the operation check results to all devices (including the image forming apparatus 2) on the network 6 that use the data delivery apparatus 1.

By configuring the availability notification unit 14 in this manner, the data delivery apparatus 1 can periodically check operations of all workflows on its own, and thus can prevent the user from being able to select workflows that cannot execute delivery processing.

For example, when the image forming apparatus 2 acquires the workflow selection screen information from the data delivery apparatus 1 and then displays the workflow selection screen, the image forming apparatus 2 can display only selection buttons for available workflows based on the above-mentioned notifications acquired from the data delivery apparatus 1 up to that moment.

Accordingly, the user can select desired workflows, and, without waiting for operation checks of the workflows to be made, can execute the workflows available by the data delivery apparatus 1 without failure.

In the data delivery apparatus 1, the availability notification unit 14 may be configured to function as a selection unit that selects the types of workflows to be subjected to the operation check.

The control unit 10 can function as the selection unit, for example, based on a selection instruction from an input unit (not illustrated) of the data delivery apparatus 1, or based on a selection instruction from the image forming apparatus 2 or a terminal device (not illustrated) on the network 6 used by the administrator.

By configuring the availability notification unit 14 in this manner, the administrator of the data delivery system can select workflows to be subjected to the operation check as appropriate.

Accordingly, the administrator of the data delivery system can exclude workflows that need not to be subjected to an operation check from the operation check process.

For example, based on a log of execution results of each workflow, the administrator can exclude workflows that have each failed less than a predetermined number of times in the past from workflows to be subjected to an automatic operation check. By doing so, the administrator can reduce the processing load of the data delivery apparatus 1.

In the data delivery apparatus 1, the availability notification unit 14 may be configured to function as a changing unit that changes the interval mentioned above.

In this case, the availability notification unit 14 can function as the changing unit that changes the interval for the execution unit that causes the availability notification unit 14 to operate periodically at a preset interval, for example, based on a change operation input from the input unit (not illustrated) of the data delivery apparatus 1, or based on a change operation input from the image forming apparatus 2 or the terminal device (not illustrated) on the network 6 used by the administrator.

By configuring the availability notification unit 14 in this manner, the administrator can freely set the execution interval of the workflow operation check process in the data delivery apparatus 1.

The interval may be set using a date and time, or a time. It is also possible to monitor the traffic from the network 6, and automatically execute the operation check during periods when the traffic is low.

It is also possible to group the multiple workflows to be subjected to the operation check into a plurality of groups, and set an execution interval of the operation check process for each group.

For example, a large number of execution times of the operation check can be set for a group of frequently used workflows while a small number of execution times of the operation check can be set for a group of infrequently used workflows. By doing so, the user can focus on knowing whether the frequently used workflows are available, and thus, user convenience can be improved.

Although the above-described embodiment has been described in the case in which the image forming apparatus 2 that requests the processing of workflows and the data delivery apparatus 1 that executes the workflows are different apparatuses from each other, a data processing apparatus of the present invention can also be implemented by providing the function of the data delivery apparatus 1 in a commonly used image forming apparatus.

In other words, the receiving party of the data to be processed, the identification information of the workflows to be performed on the data, and the destination information of the data, and the notified party of the result of the operation check are in the same apparatus.

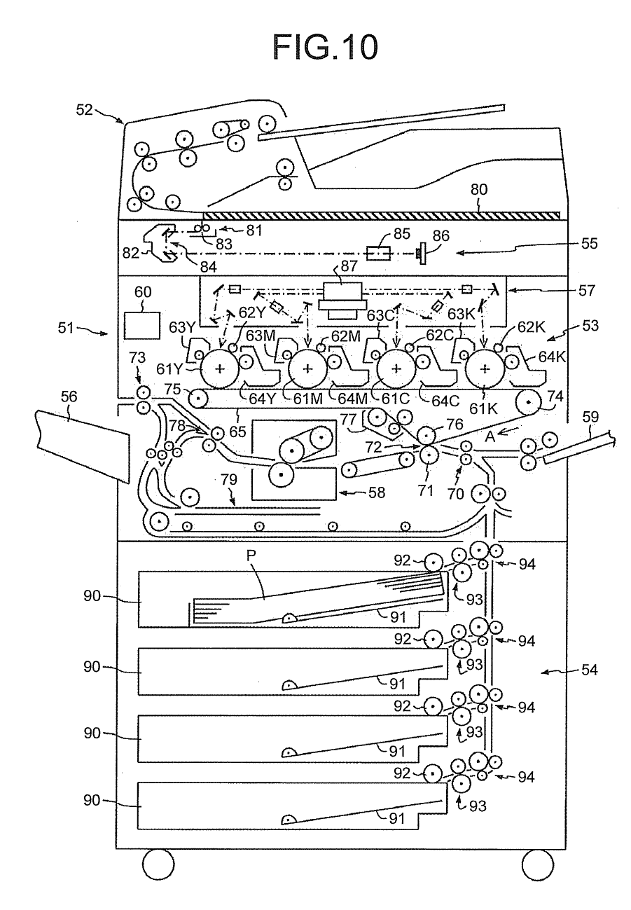

FIG. 10 is a structure diagram illustrating an internal structure example of an image forming apparatus of another embodiment of the present invention.

The image forming apparatus of the present embodiment is a structure example of a tandem indirect transfer type image forming apparatus.

A copying machine and a multifunction peripheral (MFP) are examples of the image forming apparatus having such a structure.

The image forming apparatus illustrated in FIG. 10 is provided with an automatic document feeder (ADF) 52 for automatically feeding documents onto an exposure glass 80 in an upper part of an apparatus body (hereinafter simply referred to as a “body”) 51, an image forming unit (also referred to as a “printer unit”) 53 in a central part of the body, and a paper feeding unit (also referred to as a “paper feeding bank”) 54 in a lower part of the body, where the paper feeding unit 54 is provided with a plurality of stages (four stages in the present example) of paper cassettes 90 each carrying and storing sheets (recording sheets) P.

Note that the paper feeding unit 54 can be additionally provided with other paper feeding units.

The upper side of the body 51 is provided with an operating section (not illustrated), which in turn is provided with a start key for receiving an instruction input from the user to start a copy operation, with a numeric keypad for entering settings of various parameters including the number of copies, with keys for selecting setting items such as various modes including a duplex mode (mode in which images are formed on both front and back sides of a sheet), a sheet size, and a copy density, and with a display unit, such as a liquid crystal display, for displaying various operation screens and messages to the user.

An image reading unit (also referred to as a “scanner unit”) 55 for reading an image of a document is provided above the printer unit 53, and a discharge storage unit (also referred to as a “discharge tray”) 56 is provided on the left side of the printer unit 53 in FIG. 10. The sheet P on which a monochrome or color toner image is printed (image-formed) is discharged and stored in the discharge tray 56.

The printer unit 53 is provided with drum-like photosensitive drums 61Y, 61M, 61C, and 61K (hereinafter any one of the photosensitive drums is the “photosensitive drum 61”) serving as a plurality of first image carriers whose surfaces (charged in advance) are each exposed to light to be formed with an electrostatic latent image.

An upper part of the printer unit 53 is provided with an exposing unit 57 that irradiates exposure positions (charged surfaces) on the respective photosensitive drums 61 of the printer unit 53 with laser beams corresponding to image information of respective colors, and forms the electrostatic latent images on the exposure positions.

The respective photosensitive drums 61 are provided therearound with charging units 62Y, 62M, 62C, and 62K (hereinafter, any one of the charging units is referred to as the “charging unit 62”) that uniformly charge the surfaces of the respective photosensitive drums 61, developing units 63Y, 63M, 63C, and 63K (hereinafter, any one of the developing units is referred to as the “developing unit 63”) that convert the electrostatic latent images formed on the respective photosensitive drums 61 into visible images with toners of respective colors so as to form monochromatic toner images (hereinafter referred to as “monochromatic images”), and photosensitive-drum cleaning units 64Y, 64M, 64C, and 64K (hereinafter, any one of the cleaning units is referred to as the “photosensitive-drum cleaning unit 64”) that perform cleaning processes in which the monochromatic images (visible images) on the respective photosensitive drums 61 are primarily transferred to intermediate transfer bodies (hereinafter referred to as “intermediate transfer belts”), and then, untransferred toners (residual toners) remaining on the respective photosensitive drums 61 are removed and recovered.

The printer unit 53 is further provided with an intermediate transfer belt 65 having an endless belt shape that serves as a second image carrier on which a composite color image with superimposed four colors is formed by primarily transferring each of the monochromatic images formed on the respective photosensitive drums 61 in a sequential order. The intermediate transfer belt 65 is wound around a plurality of rollers, and rotated by rotation of the rollers in the direction of arrow A in the drawing.

In addition, the printer unit 53 is provided with registration rollers 70 constituting a registration unit on the upstream side of sheet feeding and a fixing unit 58 on the downstream side of sheet feeding. The registration rollers 70 correct skew of the sheet P, and feed the sheet P toward a secondary transfer section 72 between the intermediate transfer belt 65 and a secondary transfer facing roller 71 in synchronization with the toner images on the respective photosensitive drums 61.

Then, at the secondary transfer section 72, the composite color image carried on the intermediate transfer belt 65 is secondarily transferred to the sheet P fed from any one of the paper cassettes 90 in the paper feeding bank 54 or from a bypass feed tray 59 in a sequential order, and the composite color image thus transferred is fixed by being subjected to heat and pressure in the fixing unit 58.

The fixing unit 58 is provided on the downstream side thereof with discharging rollers 73 for discharging the sheet P passed through the fixing unit 58 onto the discharge tray 56.

When making a copy by using this image forming apparatus, the user sets a document on a platen of the ADF 52, or opens the ADF 52, then sets the document on the exposure glass 80 of the scanner unit 55, and then closes the ADF 52 to hold the document therewith.

Then, when the user presses the start key on the operating section, the image forming apparatus starts the following operations.

First, if the document is set on the platen of the ADF 52, the document is automatically fed onto the exposure glass 80, and then the scanner unit 55 is driven; otherwise, if the document is directly set on the exposure glass 80, the scanner unit 55 is immediately driven. When the scanner unit 55 is driven, a first traveling body 81 and a second traveling body 82 are reciprocated in the left-right direction in the plane of FIG. 10.

Then, a light source 83 for document illumination is lit in the first traveling body 81, and the light reflected from a document surface is further reflected to be directed toward the second traveling body 82, which in turn reflects the light with mirrors 84 thereof, and introduces the light into an image reading sensor 86 including a CCD through an imaging lens 85, thus reading an image on the document. At this time, the light is photoelectrically converted for each of color-separated light components R (red), G (green), and B (blue), and electrical image signals of R, G, and B are output.

The image signals of R, G, and B are digitized, subjected to image processing, and sent to the exposing unit 57 as image signals of yellow (Y), magenta (M), cyan (C), and black (K). A light source (not illustrated in FIG. 10) including a laser diode (LD) inside the exposing unit 57 is driven by using a modulation method including phase modulation (PM) or pulse width modulation (PWM), and thereby, a laser beam corresponding to the document image is emitted.

Then, the charged surfaces (charged by the charging process by the respective charging units 62) of the respective photosensitive drums 61 are exposed to the laser beam emitted from the light source via a polygonal mirror 87 and various mirrors and lenses illustrated without reference numerals in FIG. 10, and the electrostatic latent images are formed on the charged surfaces. The depression of the start key by the user also makes a driving motor (not illustrated) rotationally drive a driving roller 74 so as to idly rotate another roller 75, a secondary transfer roller 76, and other rollers (reference numerals omitted) and thus to rotate the intermediate transfer belt 65.

At the same time, the respective photosensitive drums 61 in the printer unit 53 are rotated, and the monochromatic toners of Y, M, C, and K are attached by the respective developing units 63 to the electrostatic latent images on the respective photosensitive drums 61, thus forming the monochromatic toner images (monochromatic images) on the respective photosensitive drums 61.

Then, the monochromatic images are sequentially transferred, along with the rotation of the intermediate transfer belt 65, onto the intermediate transfer belt 65 so as to form thereon the composite color image with superimposed four colors.

First, a Y image (yellow-colored image) on the photosensitive drum 61Y is primarily transferred by a primary transfer roller (not illustrated) onto the intermediate transfer belt 65 rotating in the direction of the arrow A in FIG. 10. Next, when the Y image has moved to a position of the photosensitive drum 61M, an M image (magenta-colored image) is superimposed on the Y image, and primarily transferred by the primary transfer roller.

When the portion onto which the M image has been transferred has moved to a position of the photosensitive drum 61C, a C image (cyan-colored image) is superimposed on that portion, and primarily transferred by the primary transfer roller. Furthermore, when the portion onto which the C image has been transferred has moved to a position of the photosensitive drum 61K, a K image (black-colored image) is superimposed on that portion, and primarily transferred by the primary transfer roller.

Then, when the composite color image with superimposed four colors of Y, M, C, and K has moved by the rotation of the intermediate transfer belt 65 to the secondary transfer position between the secondary transfer roller 76 located inside the belt and the secondary transfer facing roller 71 located outside the belt, the composite color image is collectively transferred by the secondary transfer roller 76 onto the sheet P that has been fed synchronously so as to meet the timing of the movement of the composite color image.

In this manner, this image forming apparatus performs an image forming process to form one composite color image during one rotation of the intermediate transfer belt 65.

Then, after the composite color image with superimposed four colors on the intermediate transfer belt 65 is collectively transferred onto the sheet P, the untransferred toners remaining on the intermediate transfer belt 65 are removed and recovered by an intermediate transfer cleaning unit (belt cleaning unit) 77.

The sheet P fixed with the composite color image and passed through the fixing unit 58 is discharged by the discharging rollers 73 to the discharge tray 56 when a simplex mode (mode in which an image is formed on only one side of a sheet) is selected.

When the duplex mode is selected, the sheet P is fed into a duplex section 79 arranged below the printer unit 53 by a bifurcating claw 78 provided in a feed path between the fixing unit 58 and the discharging rollers 73, and then, after being reversed, fed again to the registration rollers 70. Then, a composite color image is formed this time on the back side (second side) of the sheet P, which is then discharged by the discharging rollers 73 onto the discharge tray 56.

The paper feeding bank 54 for feeding the sheet P is provided with the paper cassettes 90 in the respective paper feeding stages.

The paper cassette 90 in each of the paper feeding stages is provided with a bottom plate 91 that carries the sheet P, a pick-up roller 92 that rotates counterclockwise in FIG. 10 so as to feed the sheet P carried by the bottom plate 91, and a separator 93 composed of a feed roller and a reverse roller for separating multiple sheets P (if any) fed by the pick-up roller 92 into a single sheet.

The feeding operation from the paper feeding unit 54 is performed as follows: When unused sheets P are stored on the bottom plate 91 of any of the paper cassettes 90, the bottom plate 91 rotates toward the rising side, and thereby, the sheet P at the top position rises to a position to come in contact with the pick-up roller 92. The pick-up roller 92 rotates in that state, and thereby, the sheet is fed out of the paper cassette 90.

If two or more of the sheets P are fed out, the separator 93 separates them into a single sheet. Then, the sheet P is fed by a feeding unit 94 to the registration rollers 70 in a stopped state, and temporarily stopped there, and then, when the position of the leading edge of the sheet exactly coincides with the position of the composite color image on the intermediate transfer belt 65, the registration rollers 70 start rotating, thereby feeding the sheet P toward the printer unit 53.

After this, the image forming is performed through the processes described above, and the sheet formed with the image is discharged to the discharge tray 56.

A controller 60 (not illustrated) is provided with units serving as a control unit in charge of controlling the entire image forming apparatus and with units similar to those of the data delivery apparatus 1 illustrated in FIG. 1. This image forming apparatus is a multifunctional image forming apparatus having a function as a digital copying machine that scans a document to read an image thereon, digitizes the scanned image information, and forms the image on a sheet, a function as a facsimile apparatus that sends and receives image information of a document to and from a remote place by using the controller 60, a function as a printer that prints image information handled by a computer on a sheet, and the above-described function as the data delivery apparatus 1.

In this image forming apparatus, when the user uses workflows, the controller 60 displays a workflow selection screen on an operation and display unit, and when a workflow is selected by using the workflow selection screen, the controller 60 performs an operation check with respect to the processes in the selected workflow, and explicitly indicates, based on the operation check results, whether the selected workflow is available.

Then, if the workflow is available, the controller 60, for example, applies image conversion processing to image data read from a document, then attaches the converted image data to electronic mail, and performs SMTP delivery processing.

In this manner, the user is enabled to execute processing in the image forming apparatus using workflows, and when the user uses a workflow, the workflow is checked whether it is available, and the result is explicitly indicated to the user. Therefore, the user can easily judge whether the workflow the user wants to use is available, and thus, user convenience can be improved.

The data processing apparatus of the present embodiment can judge in advance whether processes in a workflow can be performed successfully before the workflow is used, and if the workflow is judged to surely result in a failure, the data processing apparatus can notify the user that the workflow is not available before the user uses the workflow.

Therefore, the user is able to know that a process in the selected workflow will result in a failure before executing the process, and thereby, does not need to execute the workflow in which the process will result in a failure. Thus, user convenience can be improved.

A data processing apparatus according to the embodiments allows a user to easily check whether processes in a workflow will be performed successfully before executing the processes.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data processing apparatus comprising:
a workflow storage unit configured to store therein a workflow indicating content of processing to be performed on data;
a reading unit configured to, when receiving data, identification information of a workflow to be performed on the data, and destination information of the data, read the workflow corresponding to the identification information from the workflow storage unit;
a processing unit configured to process the received data based on the workflow read by the reading unit and deliver the processed data to an apparatus indicated by the destination information; and
an availability notification unit configured to, in response to an operation check request that includes the identification information of the workflow stored in the workflow storage unit, cause the reading unit to read the workflow corresponding to the identification information from the workflow storage unit, cause the processing unit to perform an operation check based on the workflow thus read, and issue a notification of a result of the operation check.

2. The data processing apparatus according to claim 1, wherein the workflow storage unit stores therein a plurality of types of workflows.

3. The data processing apparatus according to claim 1, further comprising an execution unit configured to periodically cause the availability notification unit at a preset interval to perform a process in which the processing unit performs an operation check based on the workflow stored in the workflow storage unit and a notification of a result of the operation check is issued.

4. The data processing apparatus according to claim 3, further comprising a selection unit configured to select a type of the workflow to be subjected to the operation check caused by the execution unit.

5. The data processing apparatus according to claim 3, further comprising a changing unit configured to change the interval.

6. The data processing apparatus according to claim 1, further comprising a unit configured to generate the data to be processed, select the workflow to be performed on the data, receive the destination information of the data, and receive the notification of the result of the operation check.

7. A data processing method comprising:
reading, when receiving data, identification information of a workflow to be performed on the data, and destination information of the data, the workflow corresponding to the identification information from a workflow storage unit, the workflow indicating content of processing to be performed on the data;
processing the received data based on the workflow;
delivering the processed data to an apparatus indicated by the destination information; and
in response to an operation check request that includes the identification information of the workflow stored in the workflow storage unit, reading the workflow corresponding to the identification information from the workflow storage unit, performing an operation check based on the workflow thus read, and issuing a notification of a result of the operation check.

8. The data processing method according to claim 7, wherein the workflow storage unit stores therein a plurality of types of workflows.

9. The data processing method according to claim 7, further periodically performing, at a preset interval, a process in which an operation check is performed based on the workflow stored in the workflow storage unit and a notification of a result of the operation check is issued.

10. The data processing method according to claim 9, further comprising selecting a type of the workflow to be subjected to the operation check.

11. The data processing method according to claim 9, further comprising changing the interval.

12. The data processing method according to claim 7, further comprising:
generating the data to be processed;
selecting the workflow to be performed on the data;
receiving the destination information of the data; and
receiving the notification of the result of the operation check.

13. A non-transitory computer-readable recording medium with an executable program stored thereon, wherein the program instructs a computer to perform:
reading, when receiving data, identification information of a workflow to be performed on the data, and destination information of the data, the workflow corresponding to the identification information from a workflow storage unit, the workflow indicating content of processing to be performed on the data;
processing the received data based on the workflow;
delivering the processed data to an apparatus indicated by the destination information; and
in response to an operation check request that includes the identification information of the workflow stored in the workflow storage unit, reading the workflow corresponding to the identification information from the workflow storage unit, performing an operation check based on the workflow thus read, and issuing a notification of a result of the operation check.
